(19) United States
(12) Patent Application Publication
(10) Pub. No.: US 2009/0188524 A1
(43) Pub. Date: Jul. 30, 2009

(54) AUTOMATIC INSITU POST PROCESS CLEANING FOR PROCESSING SYSTEMS HAVING TURBO PUMPS

(75) Inventors: Jason J. New, St. Paul, TX (US); Antonio Ibarra-Rivera, Plano, TX (US); Joe M. Bockemehl, JR., Caddo Mills, TX (US)

Correspondence Address: TEXAS INSTRUMENTS INCORPORATED, P O BOX 655474, M/S 3999, DALLAS, TX, 75265, US

(73) Assignee: Texas Instruments Inc.

(21) Appl. No.: 12/022,924

(22) Filed: Jan. 30, 2008

(51) Int. Cl. B08B 6/00

(52) U.S. Cl. 134/1.1; 134/56 R

(57) ABSTRACT

An automatic method (100) of in-situ cleaning a processing system (211) including a process chamber (213) pumped by a roughing pump (219) and a turbomolecular pump (217) includes the steps of automatically performing a first RF plasma clean (110) (referred to herein as a chamber clean) to clean the process chamber, wherein the turbomolecular pump (217) is isolated and the roughing pump (219) pumps the processing chamber (213). The turbomolecular pump (217) is automatically switched on to pump the processing chamber (213). While the turbomolecular pump is pumping the processing chamber (213), a second RF plasma clean (115) (referred to herein as an automatic turbo clean) is performed clean the turbomolecular pump (217). In embodiments of the invention the turbo clean (115) automatically sets at least one gas flow, an RF power, and a pressure in the chamber (213).

### FIELD OF THE INVENTION

Embodiments of the invention relate to cleaning semiconductor processing systems having turbomolecular pumped process chambers.

### BACKGROUND

Achieving high yields in semiconductor processes requires that the processes have low defect densities. Particulates are one important class of defects. Particulates can introduced by processes including etch, film deposition (e.g. sputter, LPCVD or PECVD), and chemical mechanical planarization (CMP). The defects are generally characterized and defect source analysis (DSA) is performed to identify the source of the defects. Process changes can then be implemented in order to reduce or eliminate the various defect types, and the results can be verified through further inspections.

Processes which include an evacuated process chamber include some pumping means. In the cases of a deposition system, the inner surfaces of the pump as well as the process chamber generally gets coated with the deposition. As known in the art, both the pump as well as the process chamber must be cleaned periodically to minimize defects added to the wafers during processing, such as at weekly or bi-weekly intervals.

Certain processing systems include both a roughing pump to provide an initial rough vacuum and a turbomolecular pump (also called turbopumps) that is turned on after rough vacuum is achieved to provide a high vacuum. Buildup of deposited layers and particulates within turbo pumps of such tools is generally the leading cause of particles added at certain process steps, such as high density plasma shallow trench isolation (HDP STI). In an STI process, a semiconductor substrate, typically comprising silicon, silicon/germanium, silicon carbide or germanium is anisotropically etched to form shallow trench isolation (STI) structures, thereby defining active regions on the surface of the semiconductor substrate. As known in the art, the HDP STI deposition fills the trenches. Such deposition tools generally utilize turbopumps to achieve the high vacuum level required for proper operation. The deposition is followed by planarization, such as using Chemical Mechanical Polishing (CMP). Particles added at HDP STI deposition are known to lead to “ripout” type defects (e.g. voids) and other defects which can result in significant end of line yield loss. A plasma clean may be used to clean the process chamber of deposition systems and other systems that may accumulate coatings and/or particulates. In the case of a processing system that includes both a roughing pump and turbomolecular pump, the turbomolecular pump is gated off (e.g. using a gate valve) to allow the roughing pump to maintain the rough vacuum generally used for the plasma clean.

Soon after their introduction, turbomolecular pumps were found to be a significant source of particles due to the buildup of deposition within them over time. Shortly after this finding, turbomolecular pumps were periodically physically removed from the system for cleaning, and were placed back in the system after cleaning.

It is now known to perform a periodic clean of the turbomolecular pumps, referred to herein as a periodic turbo clean (PTC), where the turbomolecular pump can remain connected to the system and yet still be cleaned. In available PTCs, software implements an RF plasma chamber clean to remove the deposition or other material, followed by a passivation step, then a pre-coat step. The chamber clean generally includes a high flow clean portion and a low flow clean portion. The term “flow” refers to the amount of gas (e.g. NF₃) used during that part of the clean. The high flow portion of the clean is to clean the upper part of the chamber and the low flow portion is to clean the inside of the injectors and lower parts of the chamber. The passivation step is used to passivate or deplete the fluorine that is generated during the chamber clean. The passivation is followed by a pre-coat. The pre-coat is used to season the chamber.

The PTC requires that the system be moved into a software status offline. While the system is offline, it is not available to run production. For the PTC a technician must manually set the gas flows, and the RF power for the heat step which is to run for a predetermined amount of time to heat the chamber. The turbo gate valves are manually opened prior to the heat step. Once the heat step is completed the technician, who must keep track of the elapsed time, comes back and sets the gas flows, RF power, and pressure for the turbo clean. After a sufficient time for the turbo clean has elapsed, the technician and comes back and again manually sets the gas flows, RF power, and pressure for the passivation step. Again the technician must remain aware of how long the passivation step has run and must come back and manually turn off the passivation. This method is time consuming with a total time to complete being about 2.5 to 3 hours, and also being manual in many aspects, is thus susceptible to mistakes.

The amount of maintenance required to maintain acceptable particle performance for processing systems, such as deposition systems, is high due to lengthy maintenance cycles associated with the heavily manual turbo clean steps and results in substantial cost as well as an increase in cycle time. Because of the lengthy turbo cleans, RF chamber cleans are generally performed a plurality of times before a turbo clean is performed. What is needed is an improved method for cleaning turbomolecular pumps that improves the level of automation, reduces the amount of maintenance required to maintain acceptable particle performance, and reduces system down time, and makes more frequent turbo cleans practicable.

### SUMMARY

This Summary is provided to comply with 37 C.F.R. §1.73, requiring a summary of the invention briefly indicating the nature and substance of the invention. It is submitted with the understanding that it will not be used to interpret or limit the scope or meaning of the claims.

An automatic method of in-situ cleaning a processing system comprising a process chamber pumped by a roughing pump and a turbomolecular pump, comprises the steps of automatically performing a first RF plasma (referred to as a chamber clean) to clean the process chamber, wherein the turbomolecular pump is isolated and the roughing pump pumps the processing chamber. Automatically the turbomolecular pump is switched on to pump the processing chamber. While the turbomolecular pump is pumping the processing chamber, a second RF plasma clean (referred to herein as an automatic turbo clean) is performed clean the turbomolecular pump. In embodiments of the invention the turbo clean automatically sets at least one gas flow, an RF power, and a pressure in the chamber.

### DESCRIPTION OF THE DRAWINGS

FIG. 1 is a flow chart for an exemplary chamber process clean sequence including an automatic turbo clean, according to an embodiment of the invention.

FIG. 2 illustrates an example of a system comprising a processing chamber in which methods of automatic cleaning including automatic turbo cleaning according to the invention may be conducted.

### DETAILED DESCRIPTION

The present invention is described with reference to the attached figures, wherein like reference numerals are used throughout the figures to designate similar or equivalent elements. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operations are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

In one embodiment of the invention a method of automatic in-situ cleaning a processing system comprising a process chamber pumped by a roughing pump and a turbomolecular pump is described. The method comprises automatically performing a first RF plasma (chamber clean) to clean the process chamber, wherein the turbomolecular pump is isolated and the roughing pump pumps the processing chamber. The turbomolecular pump then is automatically switched to pump the processing chamber. While the turbomolecular pump is pumping the processing chamber, a second RF plasma clean pump (referred to herein as an automatic “turbo clean”) is performed to clean the turbomolecular pump. A turbomolecular passivation step can be automatically performed to passivate the turbomolecular pump. Accordingly, this method is a modification of a conventional OEM chamber clean program to now include an automatic turbo clean and generally a turbo passivation following the in-situ chamber clean. As described below, not only does method according to embodiments of the invention reduce particle counts, cleaning including turbo cleaning according to the invention reduces scheduled PM time and thus increases chamber availability.

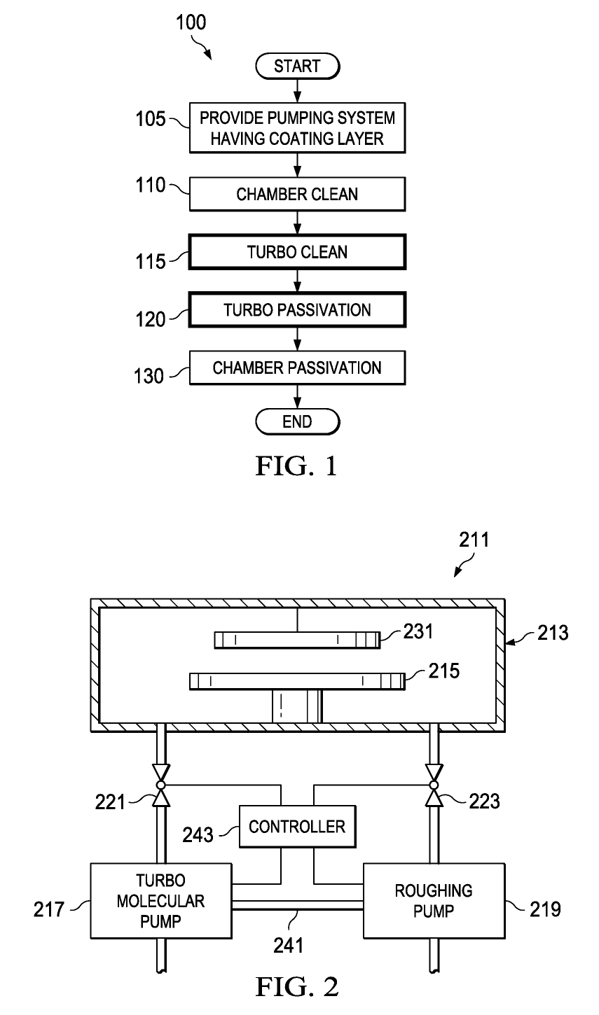

FIG. 1 is a flow chart for an exemplary process system clean sequence including an automatic turbo clean 100, according to an embodiment of the invention. New inserted steps as compared to the conventional chamber process cleaning sequence provided by conventional OEM software are shown in boxes having thick borders to highlight the same and comprise steps 115 and 120. In step 105, a system having a process chamber pumped by both a roughing pump and a turbomolecular pump is provided, wherein the system has a coating layer therein, such as a deposition layer or a particle layer from an etch or other removal process. In the case of a deposition, the deposition can be any deposition, such as a sputter or vapor deposition (CVD, LPCVD, PECVD). The clean sequence (steps 110-130) can be initiated after a predetermined deposited thickness has accumulated, after a certain number of wafers have been processed, after a certain period of time, or other suitable parameter. In step 110, an RF plasma chamber clean occurs. Step 110 can be broken up into high flow and low flow sub-steps. In the case of removal of deposited silicon oxide the first sub-step can comprise a high flow RF chamber clean (NF₃ flow=800 to 990 sccm, O2 flow=100 sccm, pressure=1 to 2 Torr, high frequency (13.56 MHz) RF power=4,000 to 4,300 Watts). The second sub-step can comprise a low flow chamber clean (NF₃ flow=100 to 300 sccm, O₂ flow 0 to 30 sccm, pressure=1 to 2 Torr, high frequency (13.56 MHz) RF power=4,000 to 4,500 Watts.

Rather than proceeding to the chamber passivation step 130 in accordance with the sequence provided by conventional OEM software following the RF plasma chamber clean (step 110), the invention adds step 115 (automatic turbo clean) and optional step 120 (turbo passivation) before the chamber passivation step 130. During the turbo clean and turbo passivation the turbo pump is used to pump the processing chamber, while the roughing pump is generally gated off. In the case of removal of an oxide coating, such as deposited silicon dioxide, in one particular embodiment the automatic turbo clean (step 115) can comprise a chamber pressure of 50 to 200 mTorr, an RF power of 2,000 to 6,000 Watts, an NF₃ flow of 800 to 1,200 sccm and O₂ flow of 70 to 130 sccm. The pumps generally start spooling down at the beginning of the turbo clean, but can completely stop by the end of the turbo clean. The clean generally does not start until the chamber pressure reaches about 100 mTorr (0.100 mm Hg), where the pressure rises as the turbos spin down. The turbo gate valves are generally open and the roughing pump is pumping on the chamber through the turbo pumps.

Again in the case of a silicon oxide deposition system the automatic turbo passivation step (step 120) can comprise in one particular embodiment a H₂ flow of 700 to 1,300 sccm, and O₂ flow of 200 to 400 sccm, an Ar flow of 200 to 400, a pressure of 50 to 200 mTorr, and an RF power of 2,000 to 3,000 Watts.

Finally, in step 130 an automatic chamber clean passivation follows. The process ends and the system is placed back in service. The entire clean sequence 100 can be fully automated based on executable software, such as executed by a process controller. The order of the steps can be changes, so for example the chamber passivation step can take place before the turbo clean step. However, because more NF₃ cleaning gas will be introduced into the chamber during the turbo clean the sequence shown in FIG. 1, this sequence generally provides better performance by having the automatic turbo clean take place before the automatic chamber passivation step.

FIG. 2 illustrates an example of a system 211 comprising a semiconductor manufacturing processing chamber 213 in which methods of in-situ automatic turbo cleaning according to the invention may be conducted. The system 211 can be, for example, a deposition system, such as a high density plasma oxide (e.g. HDP-STI), nitride deposition or epitaxial deposition system, etch system, or a sputter system. In operation a substrate (e.g. wafer) is placed on chuck assembly 215, and can be introduced through a load lock (not shown) utilizing one of a variety of movement and positioning mechanisms (not shown) well known to those of ordinary skill in the art. Although reaction chamber 213 is shown as a single chamber processing a single wafer at a time, the invention is generally applicable to multi-chamber systems, as well as systems which batch process a plurality of wafers in a given chamber. RF electrode 231 is shown within chamber 211 which together with an RF power supply and a ground electrode is generally used to generate a plasma.

The reaction chamber 213 is connected with one or more vacuum pumps with a configuration including a turbomolecular pump 217 capable of reducing the pressure within the reaction chamber 213 to a pressure of <<about 10⁻³ Torr (1 mTorr), such as 10⁻⁶ to 10⁻¹⁰ Torr, in combination with a roughing pump 219 capable of removing a larger volume of gas from the reaction chamber to establish a pressure within reaction chamber of about 1 mTorr. Each of the pumps 217 and 219 may be connected to the chamber 213 through dedicated exhaust line controlled by one or more “gate” valves 221, 223. When the turbo gate valve 221 is open, vacuum line 241 allows the roughing pump 219 to pump on the chamber 213 through the turbo pump 217. A controller 243 having executable software is coupled to control pumps 217 and 219, valves 221 and 223, and other lines or devices connected to chamber 213.

Embodiments of the invention are generally applicable to any turbomolecular pumped processing system. The automated turbo clean and turbo passivation according to embodiments of the invention allows cleaning the turbo pumps more frequently, such as after subsequent to all RF chamber cleans, and thus keeps the turbo pumps effectively clean throughout the time period between PMs, in contrast to conventional clean programs that instead let the deposition build to a relatively thick deposition and then remove the thick deposition during the PM. Although generally described for use with semiconductor processing systems, the present invention can also be applied to glass coating and certain scientific instrumentation systems that include turbomolecular pumps, such as display coating, glass coating and imaging applications.

### EXAMPLES

Parameters for an exemplary process system clean sequence including automatic turbo clean 100 described above relative to FIG. 1, is provided below in the case of a HDP oxide deposition system, according to a particular embodiment of the invention. Step 110, RF chamber clean, can be broken up into two sub-steps. The first sub-step can comprise a high flow RF chamber clean (NF₃ flow=800 to 990 sccm, O₂ flow=100 sccm, pressure=1 to 2 Torr, high frequency (e.g. 13.56 MHz) RF power=4,000 to 4,300 Watts). The second sub-step can comprise a low flow chamber clean (NF3 flow=100 to 300 sccm, O₂ flow 0 to 30 sccm, pressure=1 to 2 Torr, high frequency (e.g. 13.56 MHz) RF power=4,000 to 4,500 Watts). Step 115, the automatic turbo clean, can comprise (NF₃ flow=990 sccm, O₂ flow=100 sccm, pressure=˜100 mTorr (not actively controlled), and high frequency (e.g. 13.56 MHz) RF power=4000 Watts. Automatic Turbo passivation, step 120 can comprise H2 flow=1000 sccm, O₂ flow=300 sccm, Ar flow=300 sccm, pressure=100 mTorr, high frequency (e.g. 13.56 MHz) RF power=2,500 Watts). Chamber passivation, step 130 can comprise H₂ flow=1500 sccm, O₂ flow=150 to 300 sccm, pressure=rising to a target of 1 to 2 Torr, and high frequency (e.g. 13.56 MHz) RF power=1,200-2,200 Watts).

For the RF chamber clean (step 110), the duration can vary depending on the calculated film accumulation inside the deposition chamber. The automatic turbo clean time (step 115) at the above described parameters can be about 11 sec, and time for the turbo passivation (step 120) at the above described parameters about 10 sec. These times are generally adjustable via a program parameter. The overall time required for the automatic turbo clean (step 115) and turbo passivation (step 120) is then the above quoted times due to the other steps of the program (e.g.—time for turbo speed to decrease/increase, and turbo heat time.). The chamber clean passivation is typically 80-180 seconds in total duration.

Particle testing was performed to compare particle counts using an inline particle monitor using a standard OEM chamber clean as compared to an exemplary chamber process clean sequence including an automatic turbo clean, according to an embodiment of the invention, such as sequence 100 described above. Using a control limit of 50 particles, post deposition cleaning including automatic turbo clean according to an embodiment of the invention was found to reduce out-of-control (0° C.) particle count incidence by up to 83%. Moreover, besides reducing particles, as noted above, the turbo clean according to the invention significantly reduces scheduled PM time and thus increases chamber availability.

While various embodiments of the present invention have been described above, it should be understood that they have been presented by way of example only, and not limitation. Numerous changes to the disclosed embodiments can be made in accordance with the disclosure herein without departing from the spirit or scope of the invention. For example, cleans for sputter and removal (e.g. etch) systems according to embodiments of the invention can be realized by changing processing parameters (e.g. gas flows, pressure and RF power) based on the particular layer or particulate material to be removed. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In particular regard to the various functions performed by the above described components (assemblies, devices, circuits, systems, etc.), the terms (including a reference to a “means”) used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the invention. In addition, while a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and/or the claims, such terms are intended to be inclusive in a manner similar to the term “comprising.”

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the following claims.

1. An automatic method of in-situ cleaning a processing system comprising a process chamber pumped by a roughing pump and a turbomolecular pump, comprising:
automatically performing a first RF plasma to clean said process chamber, wherein said turbomolecular pump is isolated and said roughing pump pumps said processing chamber;
automatically switching so that said turbomolecular pump pumps said processing chamber, and
while said turbomolecular pump is pumping said processing chamber, automatically performing a second RF plasma clean to clean said turbomolecular pump.

2. The method of claim 1, wherein said second RF plasma clean automatically sets at least one gas flow, an RF power, and a pressure in said chamber.

3. The method of claim 1, wherein while said turbomolecular pump is pumping said processing chamber, automatically performing a turbomolecular passivation to passivate said turbomolecular pump.

4. The method of claim 3, further comprising the steps of isolating said turbomolecular pump from said processing chamber and performing a passivating clean of said processing chamber after said turbomolecular passivation.

5. The method of claim 1, wherein said processing system comprises a semiconductor manufacturing deposition system, wherein said method takes place after a deposition has taken place which coats said processing chamber and said turbomolecular pump.

6. The method of claim 5, wherein said deposition system comprises a high density plasma (HDP) deposition system.

7. The method of claim 6, wherein said HDP deposition comprises silicon oxide deposition system.

8. The method of claim 1, wherein said processing system comprises an etch system.

9. The method of claim 1, wherein said processing system comprises a sputter system.

10. The method of claim 2, wherein during said second RF plasma clean said pressure is between of 50 to 200 mTorr, and said RF power is between 2,000 to 6,000 Watts.

11. The method of claim 10, wherein said gas flow during said second RF plasma clean comprises an NF₃ flow of 800 to 1,200 sccm and O₂ flow of 70 to 130 sccm.

12. The method of claim 3, wherein said turbomolecular passivation step comprises a H₂ flow of 700 to 1,300 sccm, and O₂ flow of 200 to 400 sccm, and Ar flow of 200 to 400, a pressure of 50 to 200 mTorr, and an RF power of 2,000 to 3,000 Watts.

13. The method of claim 1, wherein said second RF plasma clean is run following each occurrence of said first RF plasma clean.

14. A processing system for the manufacture of semiconductor devices, comprising:
a process chamber,
a roughing pump and a turbomolecular pump coupled to said process chamber for pumping said process chamber, and
a process controller having an executable program operable to:
(i) automatically perform a first RF plasma to clean said process chamber, wherein said turbomolecular pump is isolated and said roughing pumps said processing chamber;
(ii) automatically switch said turbomolecular pump to pump said processing chamber;
(iii) while said turbomolecular pump is pumping said processing chamber, automatically performing a second RF plasma clean to clean said turbomolecular pump, and
(iv) while said turbomolecular pump is pumping said processing chamber, automatically performing a turbomolecular passivation to passivate said turbomolecular pump.

15. A method of fabricating an integrated circuit, comprising:
providing a substrate having a semiconductor surface, and
adding or modifying said substrate or a layer on said substrate in a processing system comprising a process chamber, a roughing pump and a turbomolecular pump coupled to said process chamber for pumping said process chamber, and a process controller having an executable program operable to:
(i) automatically perform a first RF plasma to clean to clean said process chamber, wherein said turbomolecular pump is isolated and said roughing pumps said processing chamber;
(ii) automatically switch said turbomolecular pump to pump said processing chamber, and
(iii) while said turbomolecular pump is pumping said processing chamber, automatically performing a second RF plasma clean to clean said turbomolecular pump.

16. The method of claim 15, further comprising the step of (iv) while said turbomolecular pump is pumping said processing chamber, automatically performing a turbomolecular passivation to passivate said turbomolecular pump.

17. The method of claim 15, wherein said adding or modifying comprises a deposition process.

18. The method of claim 15, wherein said deposition process comprises an oxide deposition process.

19. The method of claim 18, wherein said oxide deposition process comprises a HDP-STI deposition process.

20. The method of claim 15, wherein said second RF plasma clean automatically sets at least one gas flow, an RF power, and a pressure in said chamber.
